(19) United States
(12) Patent Application Publication
(10) Pub. No.: US 2026/0020940 A1
(43) Pub. Date: Jan. 22, 2026

(54) SPATIAL INDEXING SYSTEM AND METHOD FOR DENTAL IMPRESSIONS

(71) Applicant: Kois Center, LLC, Seattle, WA (US)

(72) Inventors: John C. Kois, Seattle, WA (US); Marta Revilla León, Seattle, WA (US); Jonathan Zeitler, Seattle, WA (US)

(73) Assignee: Kois Center, LLC, Seattle, WA (US)

(21) Appl. No.: 19/277,039

(22) Filed: Jul. 22, 2025

Related U.S. Application Data
(60) Provisional application No. 63/674,104, filed on Jul. 22, 2024.

(51) Int. Cl. A61C 9/00

(52) U.S. Cl. CPC A61C 9/0006; A61C 9/0046

(57) ABSTRACT

A system and method enable repeatably aligning dental impression with patient's natural head position (NHP). Dental indexing tray is coupled to a scannable base, which pivotally engages a pivot block. The pivot block is positioned in a level position using a spirit level, and the base, pivot block and patient's face in the NHP are scanned. The scanned material provides an indexing system to align subsequent facial scans to the position of the indexing tray.

### CROSS-REFERENCE TO RELATED APPLICATION

This application claims the benefit of U.S. Patent Application No. 63/674,104, filed Jul. 22, 2024, expressly incorporated herein by reference in its entirety.

### BACKGROUND

The integration of facial references into treatment planning is fundamental to developing harmony within a patient's smile and face during prosthodontic treatment. Digital photographs or facial scanning technologies have been described to incorporate facial references into the digital environments for dentofacial analysis or diagnostic waxing procedures. The natural head position (NHP) has been defined as a reproducible position of the patient's head in an upright posture with the eyes focused on a distant point at eye level so that the visual axis is horizontal. The NHP is a standardized head position that is usually selected in maxillofacial and orthodontic specialties to assess dentofacial deformities and to acquire reproducible photographs and cephalometric recordings. In addition, the NHP has been used as a standardization method for positioning the patient's head for dentofacial esthetic analysis and for communicating the horizon orientation in relationship to the maxillary diagnostic cast mounted onto the dental articulator. Additionally, a facial reference system has been described to standardize the NHP and photographic recording for treatment planning purposes.

Computer-aided design (CAD) software programs provide the capability to incorporate digital photographs and facial scans which facilitate facially driven treatment planning. Limitations of CAD software programs include the lack of orientation of the virtual patient. Therefore, determining what is parallel to the horizon in the patient's face can be challenging. This horizon orientation information can be used as a reference when performing diagnostic waxing procedures, especially in patients with asymmetries.

Known techniques for translating patient data in the NHP into a 3-dimensional virtual patient require numerous pieces of specialized equipment. The use of such equipment can be quite cumbersome and presents the potential to introduce errors into the 3-D data. The present disclosure is directed to simplified equipment and methods for transferring patient data in the NHP into a 3-dimensional virtual patient with simplified equipment and methods that are repeatable and less cumbersome for the patients and practitioners.

### SUMMARY

Embodiments of disclosed systems and methods provide for transferring patient data in a NHP into a 3-dimensional virtual patient. Representative methods comprise the steps of mounting a bite registration material on a base of an indexing device; creating an impression by pressing the registration material into a maxillary arch of a patient; placing the patient in a natural head position using a “NHP self-balance plus mirror” method; and positioning a pivot block of the indexing device relative to the base. The method further includes the steps of generating a first scan of the indexing device and patient facial data with a portion of the indexing device held in a mount of the patient; generating a second scan of the indexing device and the impression with the indexing device removed from the mouth of the patient; generating third scan of a maxillary arch of the patient; downloading the first, second, and third scans into a computing device; and aligning the first, second, and third scans using indexing device data from the first and second scans.

In any embodiment, the “NHP self-balance plus mirror” method comprises the steps of positioning a mirror in front of the patient; and the following steps performed by the patient: adjusting a position of the mirror so that the mirror is at the patient's eye level; looking down; and looking back up into the mirror.

In any embodiment, the step of mounting a bite registration material on a base of an indexing device comprises mounting an index tray on the base of the indexing device and positioning the bite registration material on the index tray.

In any embodiment, aligning the first scan includes moving the indexing device and patient facial data from the first scan according to a first transformation determined by aligning features of the pivot block in the first scan with a reference coordinate system.

In any embodiment, aligning the second scan includes moving the scanned indexing device and impression data from the second scan according to a second transformation determined by aligning features of the pivot block in the second scan with the reference coordinate system.

In any embodiment, aligning the third scan includes moving the scanned maxillary arch to align with impression data from the second scan.

In any embodiment, the third scan includes a mandibular arch of the patient, wherein the maximal arch and the mandibular arch are in maxillary intercuspal position.

In any embodiment, the step of aligning the third scan maintains the maximal arch and the mandibular arch in the maxillary intercuspal position.

In any embodiment, the base includes a hemispherical surface sized and configured to be received by a hemispherical recess formed in the pivot block so that the pivot block pivotally engages the base.

In any embodiment, the pivot block further includes a spirit level.

In any embodiment, the step of positioning a pivot block of the indexing device relative to the base includes leveling the pivot block according to the spirit level.

In any embodiment, the step of positioning a pivot block of the indexing device relative to the base further includes aligning at least one midline groove formed on the pivot block with an alignment groove formed on the base.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a top isometric view of an indexing device according to a representative embodiment of the present disclosure, wherein the indexing device includes a pivot block, a base, and an index tray mounted to the base;

FIG. 2 is a bottom isometric view thereof with the indexing tray removed for clarity;

FIG. 3 is a top isometric view of the pivot block of FIG. 1;

FIG. 4 is a bottom isometric view thereof;

FIG. 5 is a cross-sectional view thereof;

FIG. 6 is a top isometric view of the base of FIG. 1;

FIG. 7 is a bottom isometric view thereof;

FIG. 8 is a cross-sectional view thereof;

FIG. 9 is a cross-sectional view of the pivot block and base of the indexing device of FIG. 1;

FIG. 10 shows a schematic view of a scan system that includes the indexing device of FIG. 1;

FIG. 11 shows a front view of a patient with the indexing device of FIG. 1 secured in the patient's mouth;

FIG. 12 shows an isometric view thereof;

FIG. 13 shows an isometric view of the indexing device of FIG. 1, wherein an impression of a patient's maxillary arch is formed in a registration material mounted to the index tray;

FIG. 14 shows a digitized scan of the indexing device of FIG. 13 imported into a CAD program showing an isometric view thereof, wherein the CAD program includes a reference coordinate system and a reference pivot block;

FIG. 15 shows the digitized scan of the indexing device shown in FIG. 14, wherein the indexing device is transformed to the reference coordinate system, and the CAD program is displaying an isometric view thereof;

FIG. 16 shows the digitized scan of the indexing device shown in FIG. 15, wherein the CAD program is displaying a front view thereof;

FIG. 17 shows the digitized scan of the indexing device shown in FIG. 15, wherein the CAD program is displaying a side view thereof;

FIG. 18 shows a digitized scan of the patient's maxillary and mandibular arches in the maxillary intercuspal position;

FIG. 19 shows a digitized scan of the maxillary and mandibular arches in the maxillary intercuspal position of FIG. 18, wherein the maxillary arch is aligned with the impression in the registration material mounted to the index tray;

FIG. 20 shows a reference facial scan aligned with the maxillary and mandibular arches of FIG. 19 and the indexing device of FIG. 1;

FIG. 21 shows the reference facial scan, maxillary arch, and mandibular arch of FIG. 20 with the indexing device removed; and

FIG. 22 shows a representative embodiment of a method for using the indexing device of FIG. 1 to provide a 3D scan of the teeth and facial features of a patient when the patient is in the natural head position.

### DETAILED DESCRIPTION

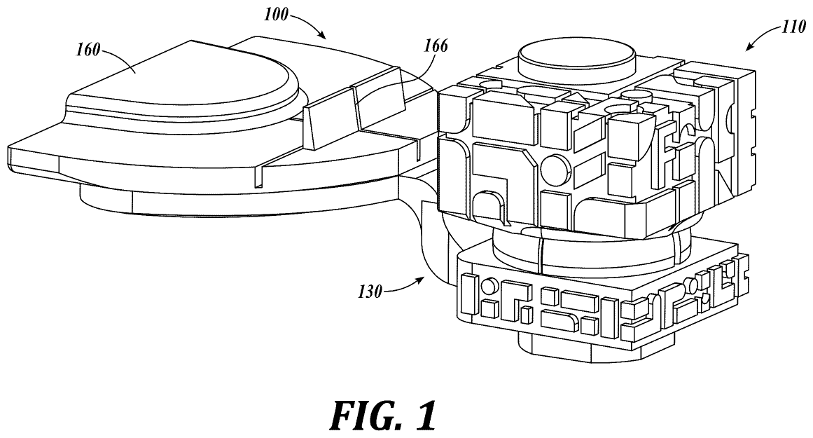

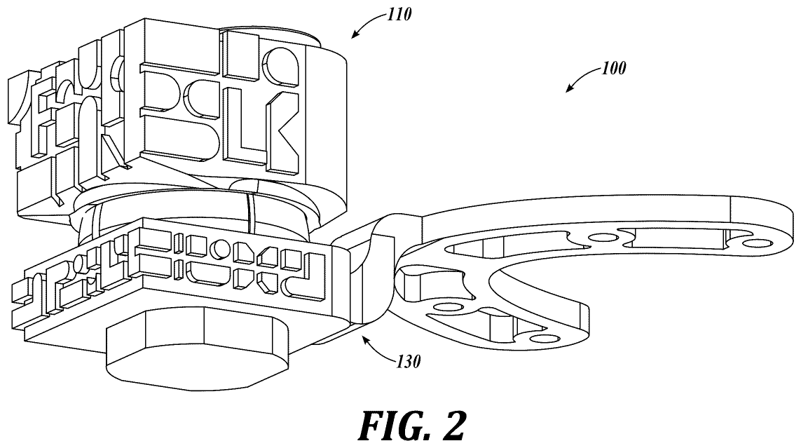

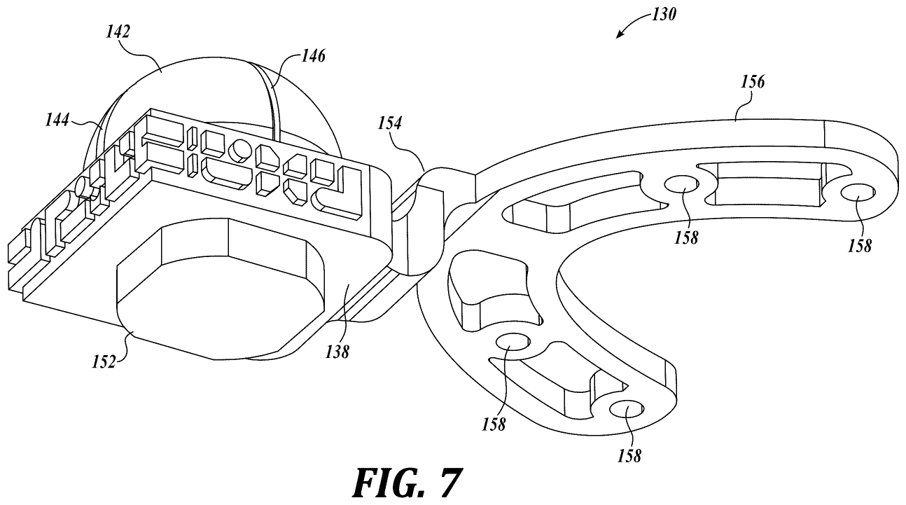

Referring to FIGS. 1-9, a representative embodiment of an indexing device 100 according to aspects of the present disclosure will be described. As shown in FIGS. 1, 2, and 9, the indexing device 100 includes a pivot block 110 pivotally mounted to a base 130. As shown in FIG. 1, the base 130 is configured to have an index tray 160 mounted thereto.

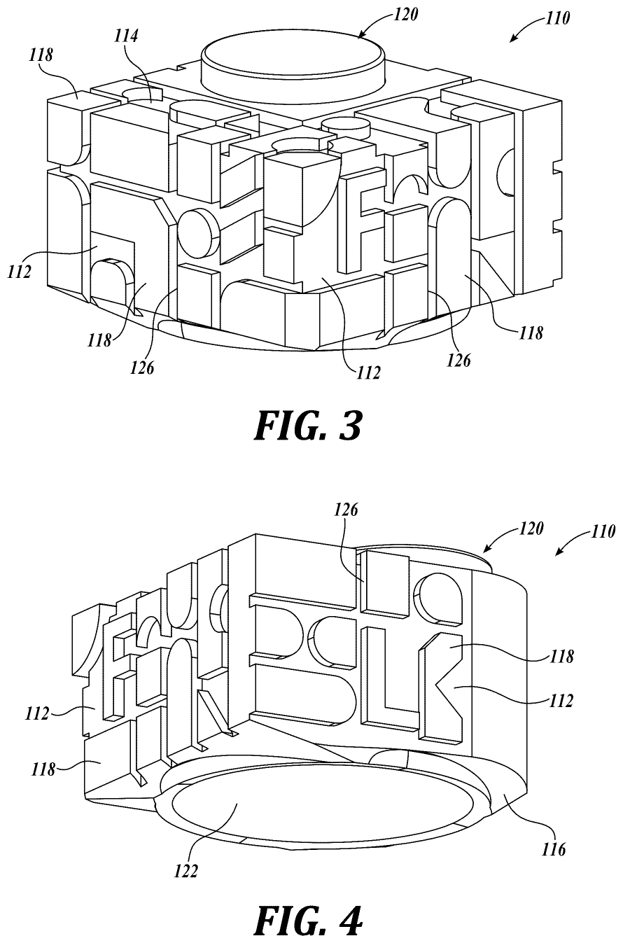

Referring now to FIGS. 3-5, the pivot block 110 will be described. The pivot block 110 has a generally cuboid shape with a top surface 114, a bottom surface 116, and a plurality of side surfaces 112. While the illustrated pivot block 110 has a generally cuboid shape, other embodiments may have any suitable shape.

A raised pattern 118 is formed on one or more of the top surface 114, bottom surface 116, and side surfaces 112. The raised patterns 118 provide reference features that enable the orientation of the pivot block 110 to be determined when the pivot block 110 is scanned or otherwise digitized and input to a CAD system. It will be appreciated that the patterns 118 included on the pivot block 110 can have any suitable form, position, and/or type suitable to enable determination of the orientation of the pivot block. The patterns 118 can be 2D patterns or 3D patterns. The patterns can be integrally formed with the body of the pivot block or added to the pivot block. The patterns 118 can be included on any single surface 112, 114, and 116 or combination of faces to enable determination of the orientation of the pivot block 110.

A spirit level 120 is mounted to the top of the pivot block 110. The spirit level provides an indication of the orientation of the pivot block 110 relative to a horizontal plane. In the illustrated embodiment, the spirit level is a circular bubble level. In alternate embodiments, the spirit level may be digital, i.e., an inclinometer. In some embodiments, a combination of digital and/or analog levels may be included. In this regard, any suitable number of sensors/devices or combinations thereof suitable for indicating the orientation of the pivot block 110 relative to a horizontal plane may be utilized. Further any such sensors/devices or combinations thereof can be mounted to or in any suitable location on or within the pivot block 110.

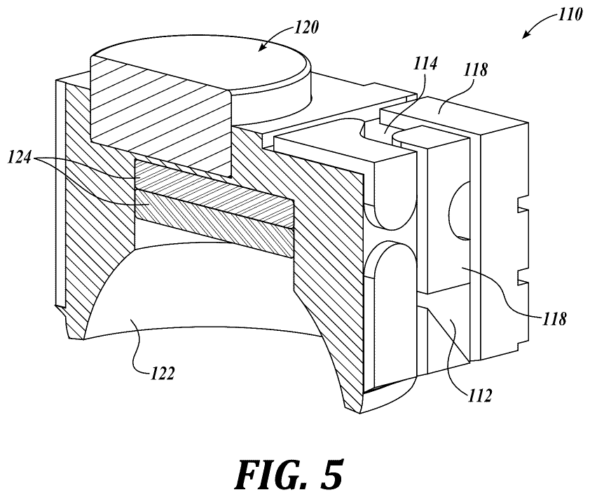

As best shown in FIGS. 4 and 5, a hemispherical recess 122 is formed in the bottom surface 138. One or more permanent magnets 124 are positioned within a cavity located between the recess 122 and the top surface 114 of the pivot block 110. The type, number, shape, and position of the one or more magnets 124 can vary within the scope of the present disclosure.

The pivot block 110 or portions thereof can be made of any suitable material or combination of materials. Further, the pivot block 110 or portions thereof can be manufactured using any suitable method, including additive manufacturing, e.g., 3D printing, casting, forging, machining, or any other suitable method or combination of methods.

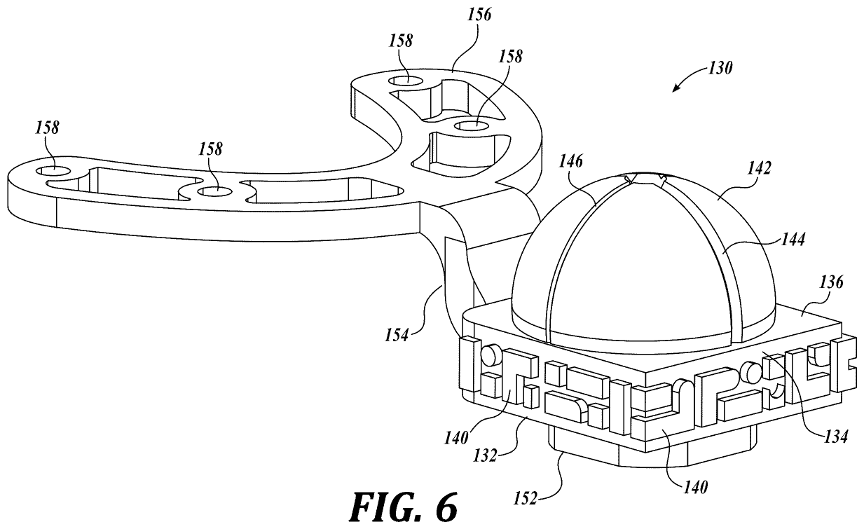

Referring now to FIGS. 6-8, the base 130 has a generally cuboid-shaped central portion with a top surface 136, a bottom surface 138, and a plurality of side surfaces 132, 134. While the illustrated central portion has a generally cuboid shape, other embodiments may have any suitable shape.

Similar to the pivot block 110, a raised pattern 140 is formed on one or more of the top surface 136, bottom surface 138, and side surfaces 132, 134 of the base 130. The raised patterns 140 provide reference features that enable the orientation of the base 130 to be determined when the base 130 is scanned or otherwise digitized and input to a CAD system. It will be appreciated that the patterns 140 included on the base 130 can have any suitable form, position, and/or type suitable to enable determination of the orientation of the pivot block. The patterns 140 can be 2D patterns or 3D patterns. The patterns can be integrally formed with the body of the base or added to the base. The patterns 140 can be included on any single surface 132, 134, 136, and 138 or combination of faces to enable determination of the orientation of the base 130.

A hemispherical surface 142 extends from the top surface 136 of the base 130. As will be explained in further detail, the hemispherical surface 143 is sized and configured to be received by the hemispherical recess 122 of the pivot block 110 as part of a pivotal connection, i.e., a ball and socket joint, between the pivot block 110 and the base 130. A first circumferential groove 144 is formed in the hemispherical surface 142 to correspond to a patient's dental midline when the indexing device is in use. A second circumferential groove 146 is formed in a vertical plane perpendicular to the first groove 144.

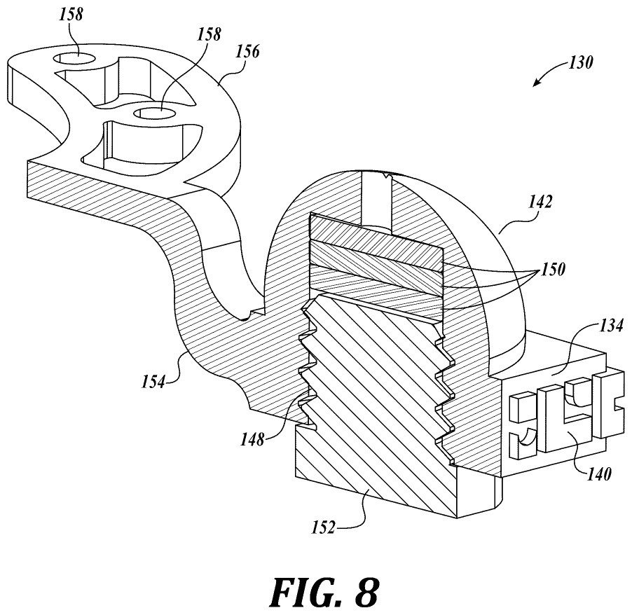

As best shown in FIG. 8, one or more permanent magnets 150 are positioned within a cavity 148 formed in the base 130. A threaded fastener 152 threadedly engages the cavity 148 to retain the magnets 150 with the cavity. The type, number, shape, and position of the one or more magnets 150 can vary within the scope of the present disclosure. Further, it will be appreciated that any suitable configuration may be utilized to secure the one or more magnets 150 within the cavity.

Referring again to FIGS. 6-8, an arm 154 extends from the central portion of the base 130. A platform 156 is positioned at an end of the arm 154 such that the arm maintains the position of the platform 156 relative to the base 130. The platform 156 is configured to have a dental index tray 160 (FIG. 1) mounted thereto. In the illustrated embodiment, the platform 156 includes a plurality of apertures 158 configured to receive alignment pins formed in an index tray 160 so that the position of the index tray relative to the base 130 is known and repeatable. It will be appreciated that the form of the platform 156 is not limited to the illustrated embodiment, and that the platform can be configured to have any suitable index tray 160 mounted thereto. The index tray 160 may be any suitable tray configured to support an occlusal registration material, such as alginate or other material used to create dental impressions.

The base 130 or portions thereof can be made of any suitable material or combination of materials. Further, the base 130 or portions thereof can be manufactured using any suitable method, including additive manufacturing, e.g., 3D printing, casting, forging, machining, or any other suitable method or combination of methods.

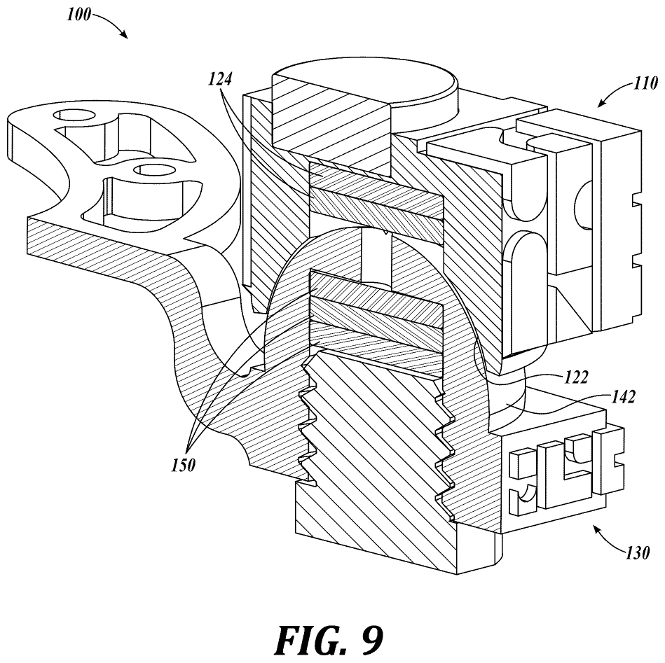

Referring now to FIG. 9, when the indexing device 100 is assembled, the hemispherical surface 142 of the base 130 is slidably engaged with the hemispherical recess 122 of the pivot block 110 so that the pivot block can pivot relative to the base. An attractive force between the magnets 124 of the pivot block 110 and the magnets 150 of the base 130 releasably secure the pivot block 110 to the base. It will be appreciated that other connections that allow the pivot block 110 to pivot relative to the base 130 are possible, and such connections should be considered within the scope of the present disclosure.

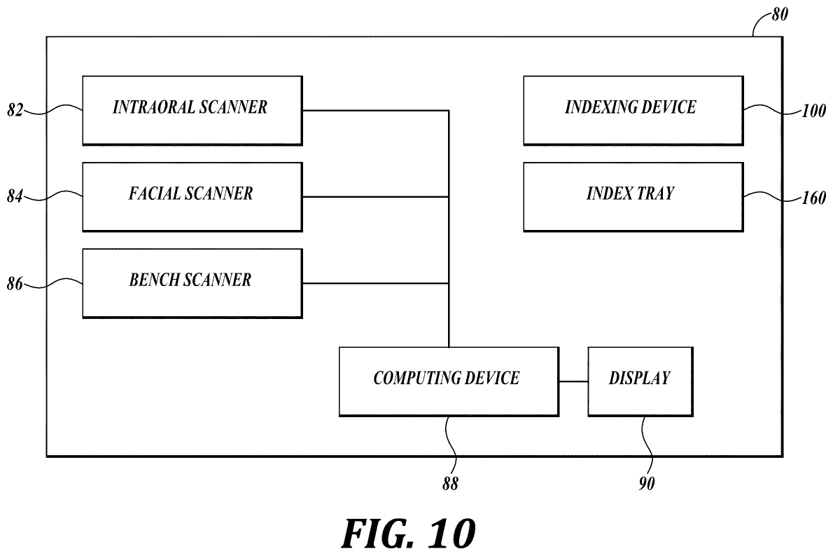

FIG. 10 shows an embodiment of a scan system 80 according to aspects of the present disclosure. The scan system 80 is configured for transplanting patient data in the NHP into a 3-dimensional virtual patient. In addition to the indexing device 100 and index tray 160 described above, the scan system further includes an intraoral scanner 82. The intraoral scanner 82 is configured to create a 3-D digital scan of the maxillary and mandibular arches with maxillomandibular registration. The scan system 80 further includes a facial scanner 84 configured to create a 3-D digital scan of a patient's facial features, including both esthetic and functional characteristics. A bench scanner 86 is configured to create a 3-D digital scan of components that are not suitable and/or convenient to scan using the intraoral scanner 82 and/or facial scanner 84. While particular scanners are described herein with respect to the disclosed scan system 80 and scanning of various equipment and physical features of a patient, it will be appreciated that these scanners are exemplary only, and any suitable scanner configured to create 3-D digital scans can be utilized, and such scanners should be considered with the scope of the present disclosure.

Still referring to FIG. 10, the intraoral scanner 82, facial scanner 84, bench scanner 86, and any other associated scanners are in communication with a computing device 88. The computing device 88 is configured to receive data exported from the scanners 82, 84, 86. The computing device 88 is programmed to manipulate the data received from the scanners using 3-D CAD software. A display 90 is optionally connected to the computing device 88.

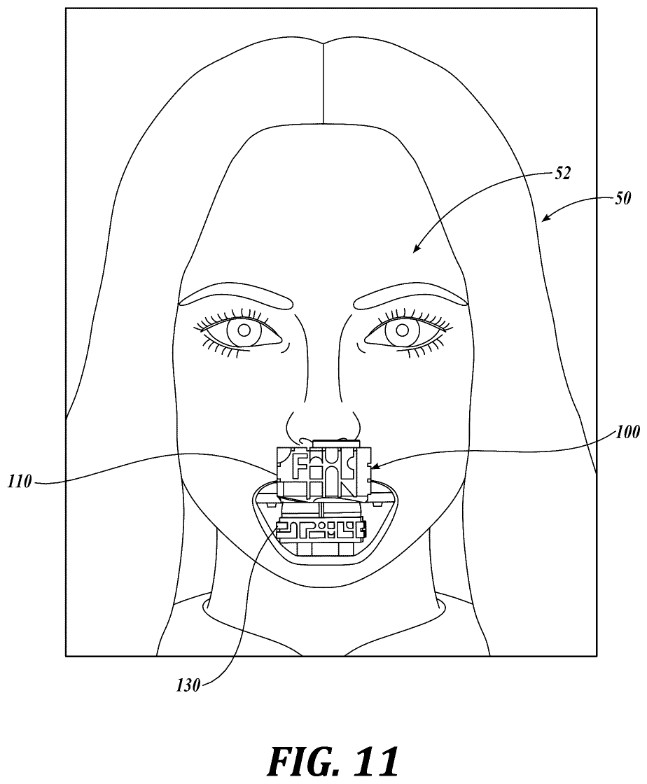

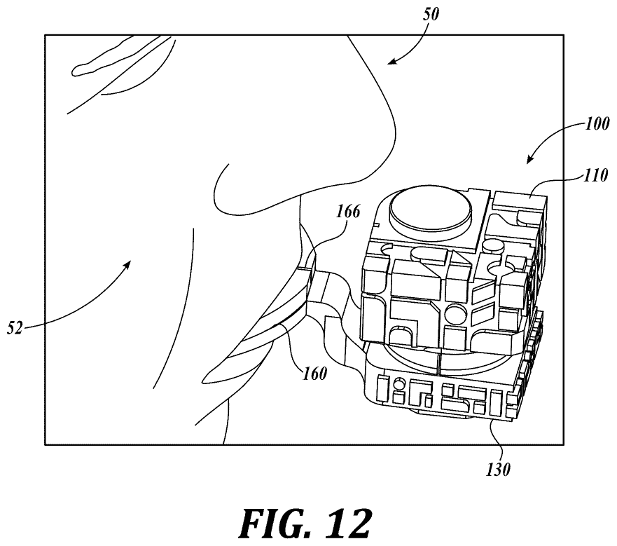

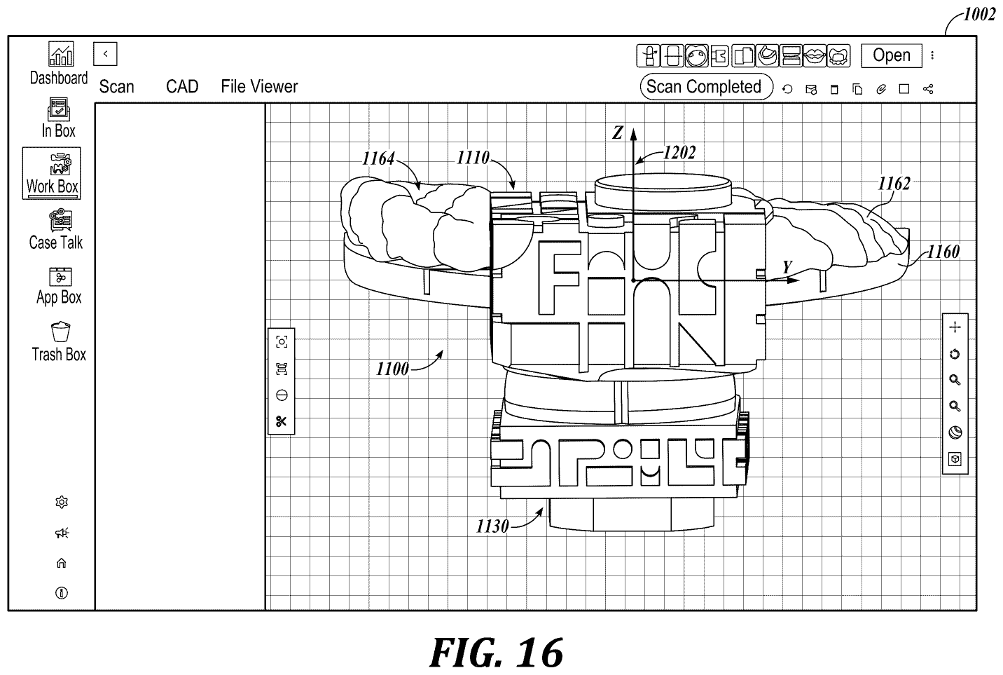

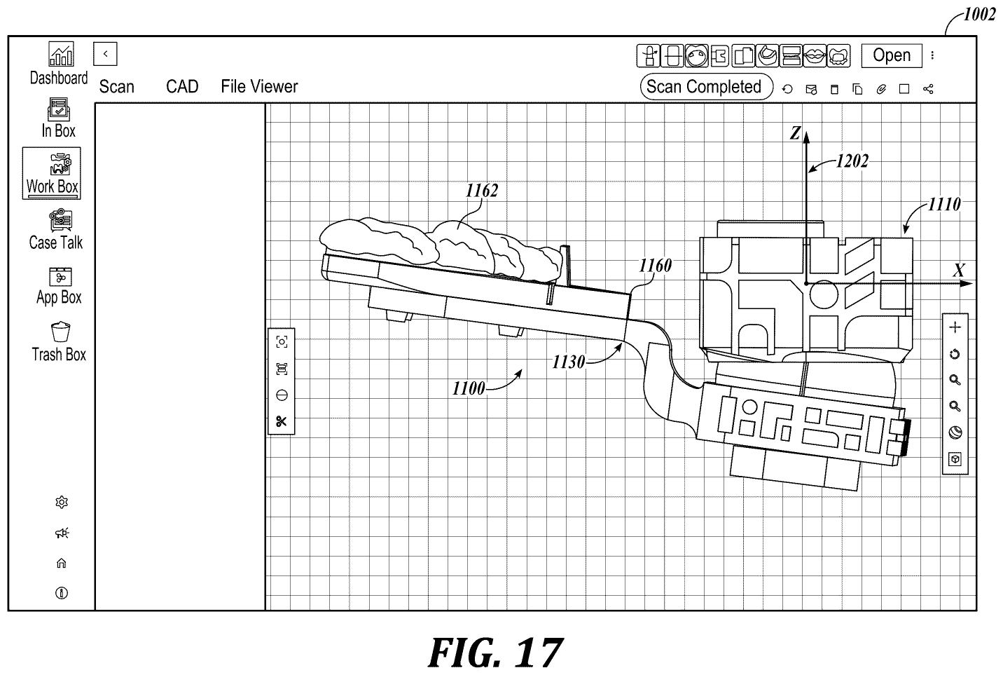

Referring now to FIGS. 11-26, use of a scan system 80 will be described. The initial steps of the process involve the patient and are typically conducted during a clinical appointment. To prepare the indexing device 100, a blank index tray 160 is attached to the base 130 of the indexing device as shown in FIG. 1. A polyvinyl siloxane occlusal registration material 162 or other suitable registration material is placed on the index tray 160. The index tray 160 is placed in the patient's mouth and pressed upward into the patient's maxillary arch, making sure to align the dental midline with a midline mark 166 on the index tray 160. The index tray 160 remains in the patient's mouth while the registration material 162 sets.

With the registration material 162 sufficiently set, cotton rolls are placed between the patient's molars and the platform 156 of the base 130 of the indexing device. The patient bites down on the index tray 160 to secure the index tray within the patient's mouth. The pivot block 110 is mounted to the base 130.

The patient is then placed in the NHP position. In an embodiment, this is accomplished by holding up a hand mirror and having the patient adjust the position of the mirror so that the mirror is at the patient's eye level. The patient then looks down and back up into the mirror, which establishes the NHP position. This is known as the “NHP self-balance plus mirror” method, but it will be appreciated that any suitable method for establishing the patient's NHP position may be utilized.

Referring to FIGS. 3, 7, 11, and 12, the pivot block 110 is adjusted with the patient in the NHP position until (1) the bubble in the spirit level 120 is centered, and (2) the midline grooves 126 in the pivot block 110 are aligned with corresponding alignment grooves 144, 146 formed in the base 130. Centering the bubble of the spirit level 120 ensures that the pivot block 110 is level, i.e., the top surface of the pivot block is horizontal. Aligning the midline grooves 126 with the alignment grooves 144, 146 ensures that the pivot block 110 is aligned in rotation relative to the dental midline.

With the pivot block 110 adjusted as described above and the patient still in the NHP position, a 3-D digital scan is taken by the facial scanner 84 of the face 52 of the patient 50, as well as the base 130 and the pivot block 110 of the indexing device 100. The scan preferably captures at least three orthogonal planes of the pivot block 110 and two side planes of the base 130 in order to capture accurately the position of the pivot block relative to the base. In any embodiment, the intraoral scanner 82 or any other suitable scanner is used to scan the pivot block 110 and base 130 in particular. In any embodiment, and number of characteristics of the pivot block and the base 130 are scanned and analyzed to determine the position of the pivot block 110 relative to the base 130.

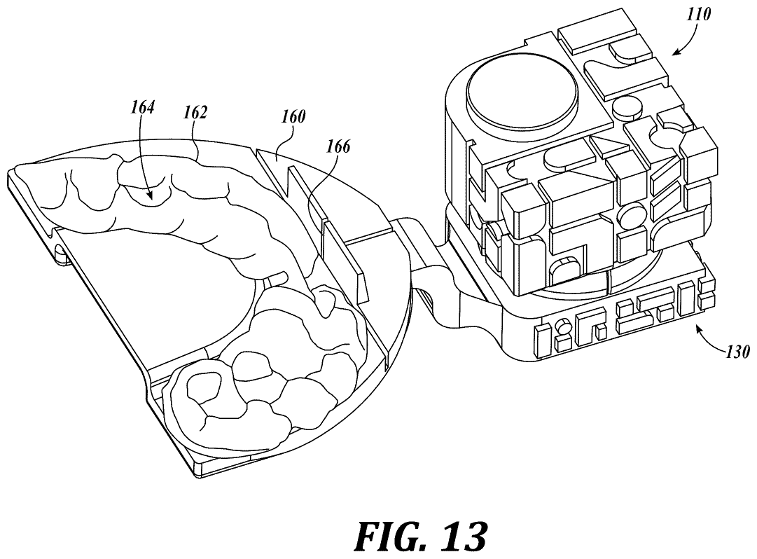

The indexing device 100 is removed from the patient's mouth, taking care to maintain the position of the pivot block 110 relative to the base 130. As shown in FIG. 13, the registration material 162 disposed on the index tray 160 includes an impression 164 of the patient's maxillary arch. A 3-D digital scan of the indexing device 100 and the registration material, including the impression 164, is taken using the bench scanner 86 or any other suitable scanner. The scan preferably captures three orthogonal planes of the pivot block 110 and two side planes of the base 130 in order to capture accurately the position of the pivot block relative to the base.

With the 3-D digital scans generated, the processing of the scans can be done without the patient present, i.e., after the clinical appointment. To begin the processing, the scan files are downloaded to a computing device 88, e.g., a computer. Specifically, the following 3-D digital scans are downloaded to the computing device 88: 1) the patient's facial features with the indexing device 100, wherein the patient is in NHP; 2) the indexing device with the index tray and an impression of the patient's maxillary arch in a registration material; and 3) the maxillary and mandibular arches with maxillomandibular registration.

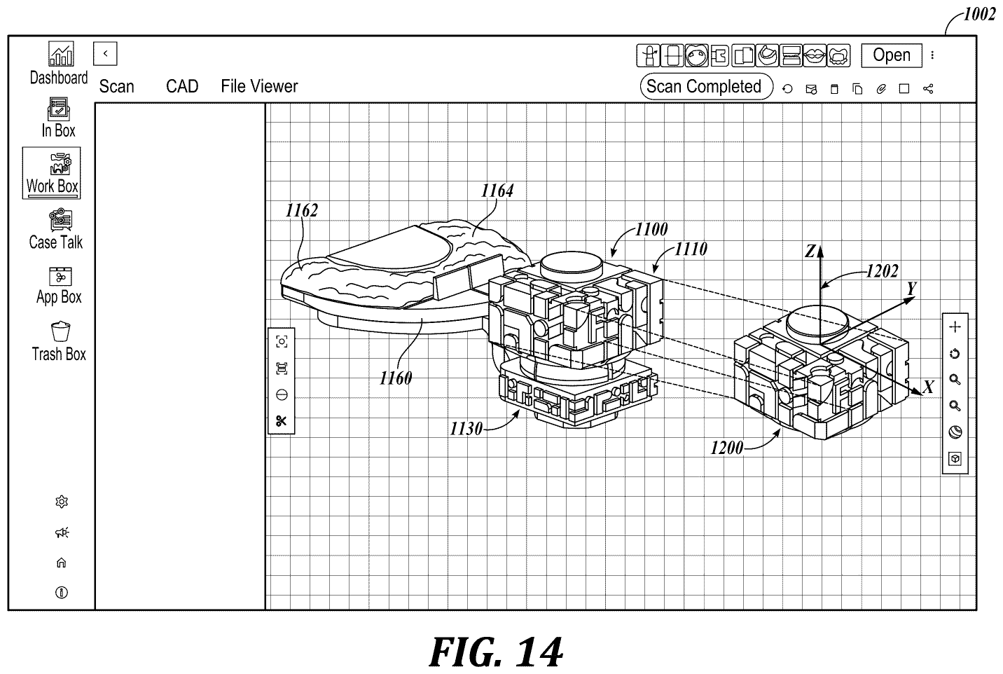

The computing device 88 is equipped with CAD software programmed to import the 3-D digital scans and convert them as necessary to enable a user to visualize, combine, and manipulate the 3-D data, as necessary. As shown in FIG. 14, the software includes a reference pivot block 1200 associated with a reference coordinate system 1202. Also shown in FIG. 14 is a CAD rendering of the downloaded scan of the indexing device 1100, which includes the base 1130 and the pivot block 1110, along with the index tray 1160 and the registration material 1162 of the impression 1164 of the patient's maxillary arch. The rendering may be displayed, for example on the display 90 of the scan system and is shown in a window of a graphical user interface 1002 (GUI).

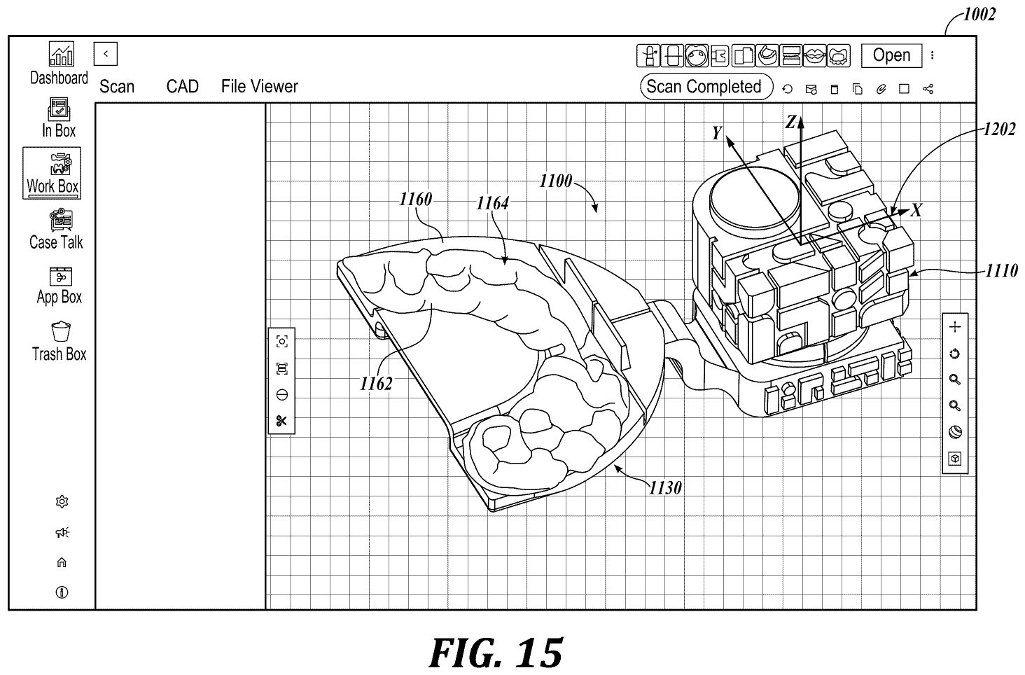

To position and orient the dental impressions 1164 of the patient's maxillary arch, the pivot block 1110, base 1130, index tray 1160, and registration material 1162 are transformed to the reference coordinate system 1202 by moving the pivot block 1110 to be aligned with the reference pivot block 1200. As shown, this is accomplished by translating the pivot block 1110 such that various features of the pivot block are coincident with corresponding features on the reference pivot block 1200. FIGS. 15-17 show the pivot block 1110, base 1130, index tray 1160, and registration material 1162 (with maxillary arch impression 1164) aligned with the reference coordinate system 1202. It will be appreciated that any number of suitable transformation techniques and algorithms can be used to align the pivot block 1110, base 1130, index tray 1160, and registration material 1162 with the reference coordinate system 1202.

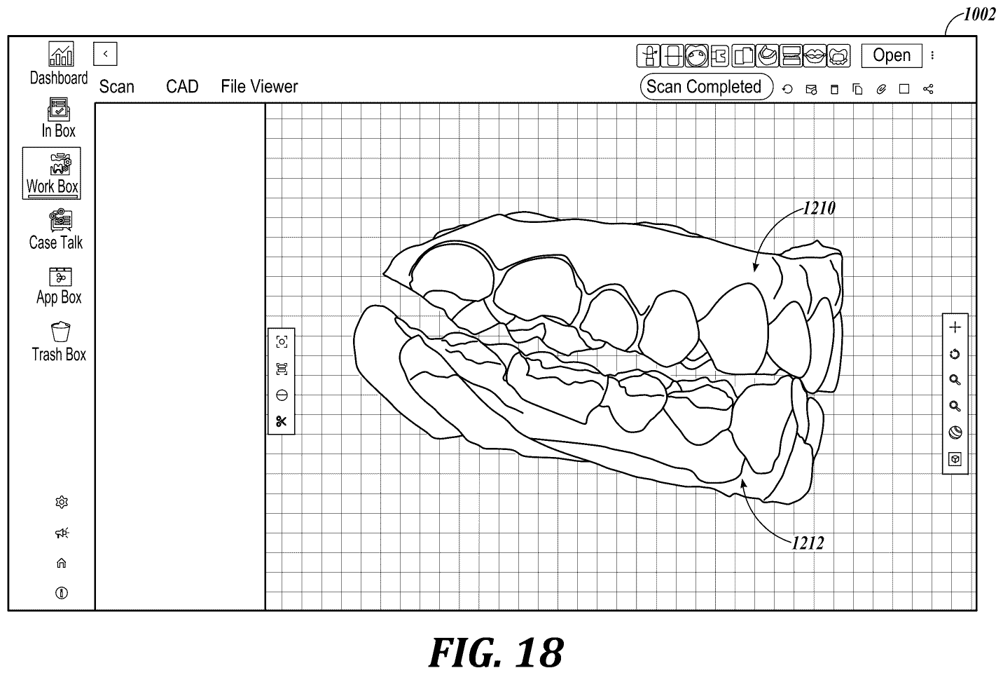

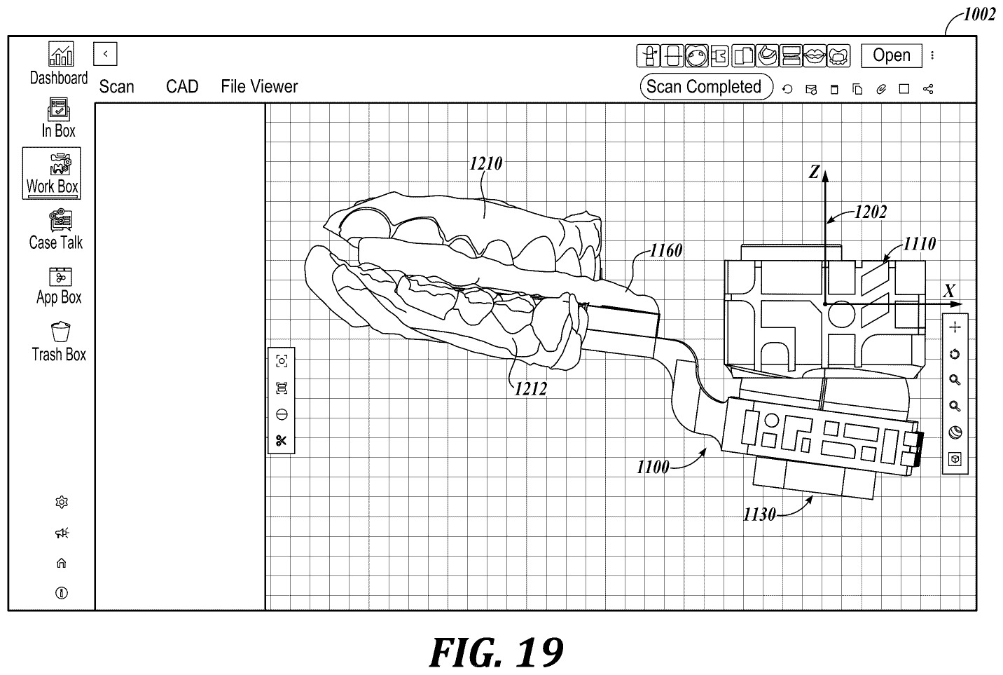

FIG. 18 shows a CAD rendering of the downloaded scan of the patient's maxillary arch 1210 and mandibular arch 1212 in the maxillary intercuspal position. To position the maxillary arch 1210 and mandibular arch 1212 to correspond to the patient's NHP position, the maxillary arch 1210 is translated and oriented so that various index points on the maxillary arch are aligned with corresponding index points in the impression 1164 of the registration material 1162. As shown in FIG. 19, the mandibular arch 1112 is translated and oriented as a unit with the maxillary arch 1210 so that the maxillary and mandibular arches maintain the maxillary intercuspal position.

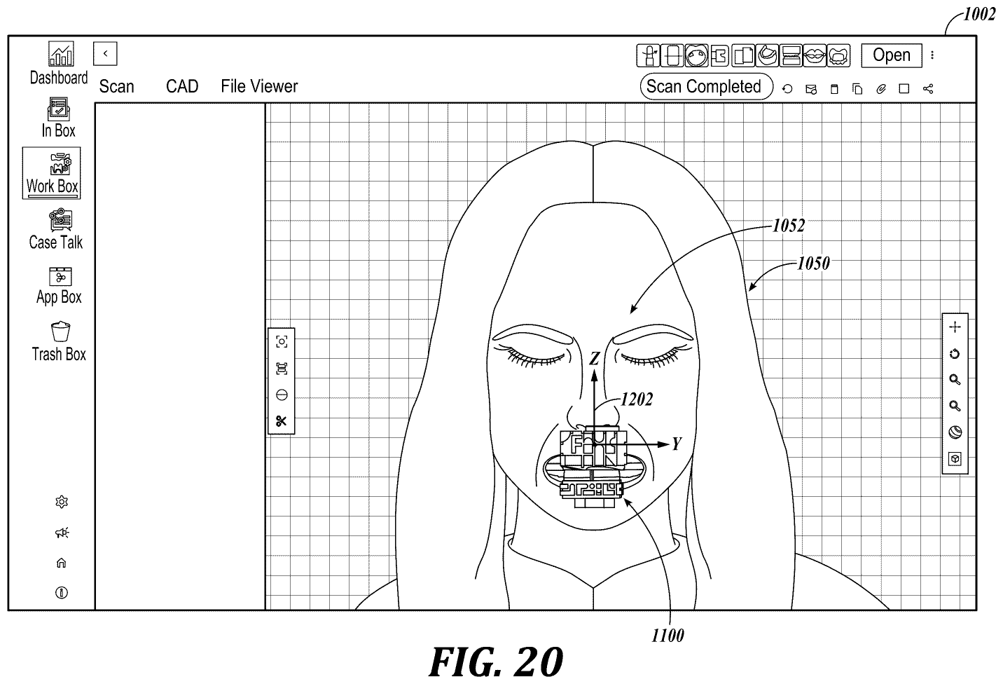

Referring to FIG. 20, a CAD rendering of the downloaded 3-D scan of the facial features 1052 of the patient 1050 in the NHP are shown with the indexing device 1100. The facial features 1052 are transformed to the reference coordinate system 1202 using the pivot block 1110 and the reference pivot block 1200. In any embodiment, the pivot block from the scan of the previously transformed indexing device 1100 with the index tray 1160 and the impression 164 is used as a reference to transform the facial features 1052 to the reference coordinate system 1202. In any embodiment, any suitable references can be used to transform the facial features 1052 to the reference coordinate system 1202.

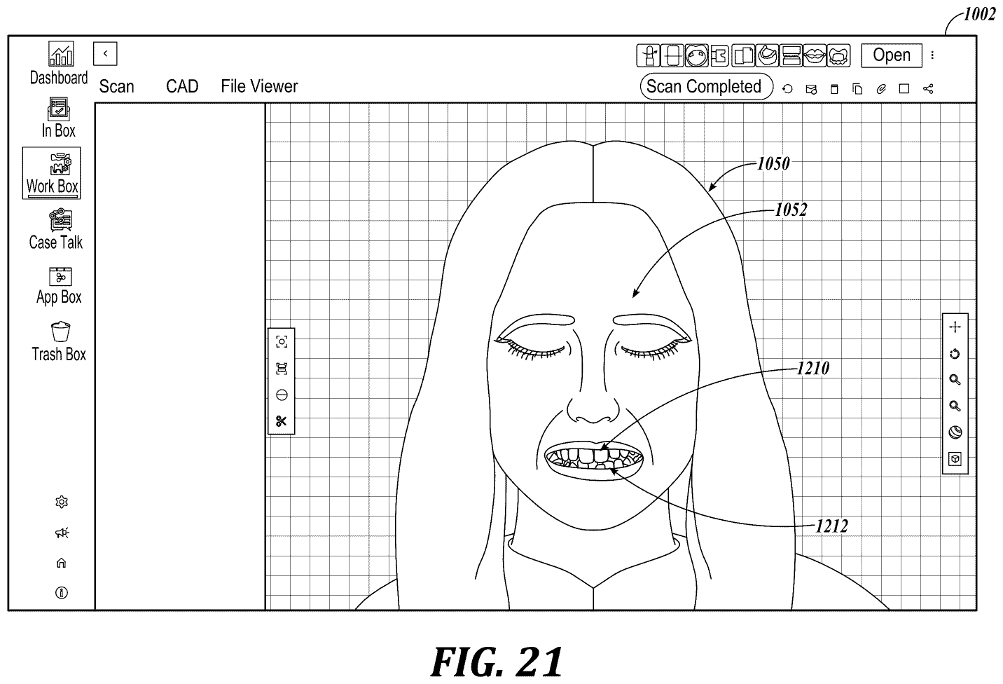

Still referring to FIG. 20, the CAD model includes patient facial features 1052 in NHP and positioned relative the reference coordinate system 1202. The CAD model also includes the patient's maxillary arch 1210 and mandibular arch 1212 in the maxillary intercuspal position and positioned relative to the reference axis. By hiding or deleting the indexing devices 1100 and registration material 1162, the rendering (as shown in FIG. 21) is left showing (1) the patient's facial features 1052 and (2) the maxillary arch 1210 and mandibular arch 1212 in the maxillary intercuspal position, wherein the position of all the rendered features are aligned with each other and correspond the NHP.

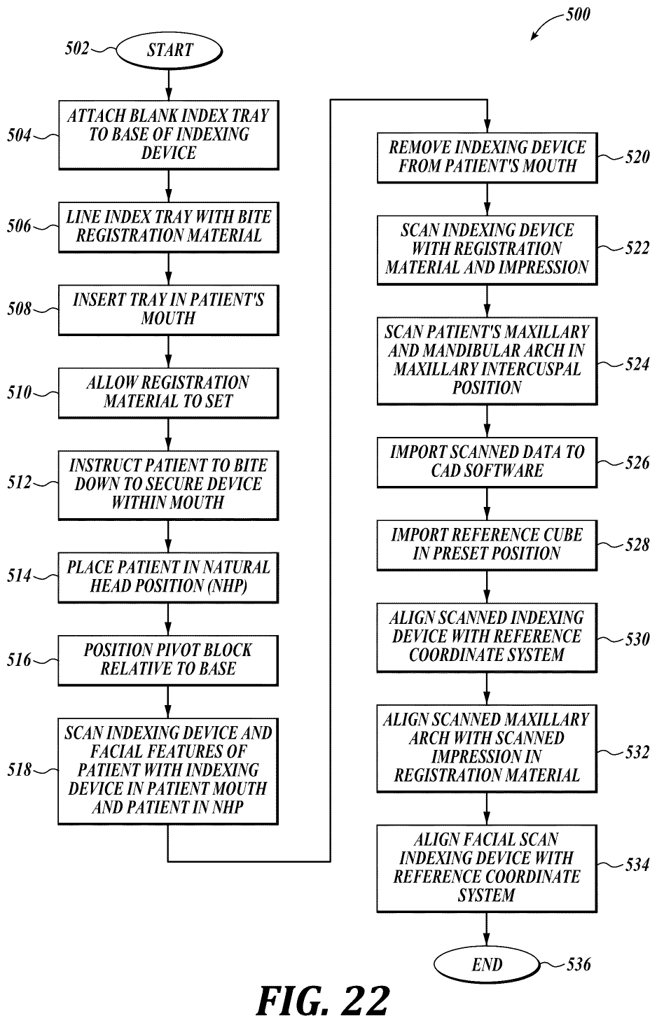

Referring now to FIG. 22, an exemplary embodiment of a method 500 for generating a 3-D CAD model of a patient's facial features in NHP with the patient's maxillary and mandibular arches in the maxillary intercuspal position. The method 500 begins at block 502 and proceeds to block 504. In block 504, a blank index tray 160 is attached to the base 130 of the indexing device 100. The method 500 proceeds to block 506, in which the index tray 160 is lined with bite registration material 162. The method 500 proceeds to block 508.

In block 508, the index tray 160 is inserted into the patient's mount and pushed upward against the patient's maxillary arch. Next, in block 510, the registration material 162 is allowed to set.

Moving on to block 512, the patient 50 is instructed to bite down on the index tray 160 to secure the indexing device 100 within the patient's mouth. The patient is then put in NHP in block 514. Moving on to block 516, the pivot block 110 is positioned relative to the base 130.

In block 518, the indexing device 100 and the patient's facial features are scanned while the indexing device is in the patient's mouth and the patient is in NHP. Next, in block 520, the indexing device is removed from the patient's mouth.

The process 500 then moves to block 522, in which the indexing device 100 with the registration material 162 and impression 164 are scanned. In block 524, the patient's maxillary and mandibular arches are scanned in the maxillary interscuspal position.

Moving on to block 526, the scanned data is imported to CAD software. In some embodiments, the software includes a reference cube, i.e., pivot block or other suitable reference feature, in a preset position. If not, a reference cube or any other suitable reference feature is imported into he CAD software in step 528. The method then proceeds to block 530.

In block 530, the indexing device 100 is aligned with the reference coordinate system 1202. Next, in block 532, the maxillary and mandibular arches are aligned with the reference coordinate system 1202 by aligning the maxillary arch with the impression 164 in the registration material 162. The process 500 proceeds to block 534, in which the patient's facial scan is aligned with the coordinate reference system 1202. The process 500 then proceeds to step 536 and ends.

The described technique uses a scan body system to assist in 3D virtual patient integration. The scan body system achieves at least the following objectives: recording the NHP of the patient, integrating the facial and intraoral digital scans. The technique facilitates data-collection procedures and reduces chair and laboratory time. A technique for registering the NHP and translating it into a CAD software program has been described.

The present disclosure references 3D facial scanning methodologies. Suitable facial scanning methodologies include but are not limited to photogrammetry or stereophotogrammetry (PG), laser-beam, and structured light scanning technologies.

Photogrammetry systems are passive methods to scan the patient's face based on taking two or more photographs from different perspectives with homologous common points, obtaining the facial reconstruction through a reverse engineering software. Active PG includes a direct illumination by the facial scanning system, while passive PG the object is being illuminated only by ambient lighting.

Laser beam and structured light-based scanners employ active 3D sensors for facial scanning procedures where light patterns are projected onto the extraoral soft tissue of the patient's face, being captured by high-resolution camera or cameras using active triangulation.

The present disclosure is not limited to use with any particular software. Any suitable software, including various CAD programs may be utilized, may be utilized, and the use of such software should be considered within the scope of the present disclosure. Treatments that can be completed after integrating the Scan Body include but are not limited to diagnostic waxing and design and fabrication of dental appliances, including but not limited to tooth-supported and implant-supported prostheses; implant-retained prostheses; removable partial denture; complete dentures; and immediate complete dentures.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

Certain embodiments disclosed herein utilize circuitry (e.g., one or more circuits) in order to implement standards, protocols, methodologies or technologies disclosed herein, operably couple two or more components, generate information, process information, analyze information, filter signals, generate signals, encode/decode signals, convert signals, transmit and/or receive signals, control other devices, etc. Circuitry of any type can be used. It will be appreciated that the term “information” can be use synonymously with the term “signals” in this paragraph.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessors that require software, firmware, and the like for operation. In an embodiment, circuitry includes one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

In an embodiment, one or more of the components of the system referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and/or flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly. it is expressly intended that all such variations, changes, and equivalents fall within the spirit and scope of the present disclosure as claimed.

1. A method for transferring patient data in a NHP into a 3-dimensional virtual patient, the method comprising the steps of:
mounting a bite registration material on a base of an indexing device;
creating an impression by pressing the registration material into a maxillary arch of a patient;
placing the patient in a natural head position using a “NHP self-balance plus mirror” method;
positioning a pivot block of the indexing device relative to the base;
generating a first scan of the indexing device and patient facial data with a portion of the indexing device held in a mount of the patient;
generating a second scan of the indexing device and the impression with the indexing device removed from the mouth of the patient;
generating a third scan of a maxillary arch of the patient;
downloading the first, second, and third scans into a computing device; and
aligning the first, second, and third scans using indexing device data from the first and second scans.

2. The method of claim 1, wherein the “NHP self-balance plus mirror” method comprises the steps of:
positioning a mirror in front of the patient; and
the following steps performed by the patient;
adjusting a position of the mirror so that the mirror is at the patient's eye level;
looking down; and
looking back up into the mirror.

3. The method of claim 2, wherein the step of mounting a bite registration material on a base of an indexing device comprises mounting an index tray on the base of the indexing device and positioning the bite registration material on the index tray.

4. The method of claim 2, wherein aligning the first scan includes moving the indexing device and patient facial data from the first scan according to a first transformation determined by aligning features of the pivot block in the first scan with a reference coordinate system.

5. The method of claim 4, wherein aligning the second scan includes moving the scanned indexing device and impression data from the second scan according to a second transformation determined by aligning features of the pivot block in the second scan with the reference coordinate system.

6. The method of claim 5, wherein aligning the third scan includes moving the scanned maxillary arch to align with impression data from the second scan.

7. The method of claim 6, wherein the third scan further includes a mandibular arch of the patient, wherein the maximal arch and the mandibular arch are in maxillary intercuspal position.

8. The method of claim 7, wherein the step of aligning the third scan maintains the maximal arch and the mandibular arch in the maxillary intercuspal position.

9. The method of claim 8, wherein the base includes a hemispherical surface sized and configured to be received by a hemispherical recess formed in the pivot block so that the pivot block pivotally engages the base.

10. The method of claim 9, wherein the pivot block further includes a spirit level.

11. The method of claim 10, wherein the step of positioning a pivot block of the indexing device relative to the base includes leveling the pivot block according to the spirit level.

12. The method of claim 11, wherein the step of positioning a pivot block of the indexing device relative to the base further includes aligning at least one midline groove formed on the pivot block with an alignment groove formed on the base.
